(19) United States
(12) Patent Application Publication
(10) Pub. No.: US 2005/0010529 A1
(43) Pub. Date: Jan. 13, 2005

(54) Method and apparatus for building a complete data protection scheme

(76) Inventors: Stephen H. Zalewski, Pleasant Hill, CA (US); Aida McArthur, Sunnyvale, CA (US)

Correspondence Address: KENYON & KENYON, Suite 600, 333 W. San Carlos, Street, San Jose, CA, 95110-2711, US

(21) Appl. No.: 10/616,819

(22) Filed: Jul. 8, 2003

(51) Int. Cl. G06F 17/60; H04K 1/00; H04L 9/00

(52) U.S. Cl. 705/54

(57) ABSTRACT

A method and apparatus for building a complete data protection scheme. A primary set of data may be protected from physical and logical failures using a replication policy, which may replicate the primary set of data at various points in the data set's history. A graphical user interface may illustrate for a user the logical source volume(s), physical failure policy, logical failure policy, replication occurrence policy, replication technology, scheduling policy and time instantiation of data protection and replication policies to facilitate data management and recovery.

### CROSS REFERENCE TO RELATED APPLICATIONS

This application is related by common inventorship and subject matter to co-filed and co-pending applications titled “Method and Apparatus for Determining Replication Schema Against Logical Data Disruptions,” “Method and Apparatus for Protecting Data Against any Category of Disruptions” and “Method and Apparatus for Creating a Storage Pool by Dynamically Mapping Replication Schema to Provisioned Storage Volumes,” filed June ______, 2003. Each of the aforementioned applications is incorporated herein by reference in its entirety.

### TECHNICAL FIELD OF THE INVENTION

The present invention pertains to a method and apparatus for building a complete data protection scheme. More particularly, the present invention pertains to the time instantiation of data protection and replication policies in order to facilitate data management and recovery.

### BACKGROUND INFORMATION

There are many methods of backing up a set of data to protect against disruptions. As is known in the art, the traditional backup strategy has three different phases—synchronization, physical backup, and resynchronization. The data being stored needs to be protected against both physical and logical disruptions. A physical disruption occurs when a data storage medium, such as a disk, physically fails. Examples include when disk crashes occur and other events in which data stored on the data storage medium becomes physically inaccessible. A logical disruption occurs when the data on a data storage medium becomes corrupted, through computer viruses or human error, for example. As a result, the data in the data storage medium is still physically accessible, but some of the data contains errors and other problems.

While conventional data methods exist to protect and recover data, they are difficult and cumbersome to use.

### SUMMARY OF THE INVENTION

A method and apparatus for building a complete data protection scheme are disclosed. A primary set of data stored in a memory may be protected from physical and logical failures using a replication policy, which may replicate the primary set of data at various points in the data set's history. A graphical user interface may illustrate for a user the logical source volume(s), physical failure policy, logical failure policy, replication occurrence policy, replication technology, scheduling policy and time instantiation of data protection and replication policies to facilitate data management and recovery.

### BRIEF DESCRIPTION OF THE DRAWINGS

The invention is described in detail with reference to the following drawings wherein like numerals reference like elements, and wherein:

FIG. 1 illustrates a diagram of a possible data protection process according to an embodiment of the present invention.

FIG. 2 illustrates a flowchart of a possible process for creating an integrated set of data protection and replication policies in order to facilitate data management and recovery.

FIG. 3 illustrates a flowchart of a possible process for modifying an integrated set of data protection and replication policies to facilitate data management and recovery according to an embodiment of the present invention.

FIG. 4 illustrates a possible GUI capable of time instantiating data protection and replication policies to facilitate data management and recovery according to an embodiment of the present invention.

### DETAILED DESCRIPTION OF THE DRAWINGS

A method and apparatus for building a complete data protection scheme are disclosed. A primary set of data stored in a memory may be protected from physical and logical failures using a replication policy, which may replicate the primary set of data at various points in the data set's history. A graphical user interface may illustrate for a user the time instantiation of data protection and replication policies to facilitate data management and recovery.

In order to recover data, an information technology (hereinafter, “IT”) department must not only protect data from hardware failure, but also from human errors and such. Overall, the disruptions can be classified into two broad categories: “physical” disruptions, that can be solved by mirrors to address hardware failures; and “logical” disruptions that can be solved by a snapshot or a point-in-time (hereinafter, “PIT”) copy for instances such as application errors, user errors, and viruses. This classification focuses on the particular type of disruptions in relation to the particular type of replication technologies to be used. The classification also acknowledges the fundamental difference between the dynamic and static nature of mirrors and PIT copies. Although physical and logical disruptions have to be managed differently, the invention described herein manages both disruption types as part of a single solution.

Strategies for resolving the effects of physical disruptions call for following established industry practices, such as setting up several layers of mirrors and the use of failover system technologies. Mirroring is the process of copying data continuously in real time to create a physical copy of the volume. Mirrors contribute as a main tool for physical replication planning, but they are ineffective for resolving logical disruptions.

Strategies for handling logical disruptions include using snapshot techniques to generate periodic PIT replications to assist in rolling back to previous stable states. Snapshot technologies provide logical PIT copies of volumes of files. Snapshot-capable volume controllers or file systems configure a new volume but point to the same location as the original. No data is moved and the copy is created within seconds. The PIT copy of the data can then be used as the source of a backup to tape, or maintained as is as a disk backup. Since snapshots do not handle physical disruptions, both snapshots and mirrors play a synergistic role in replication planning. Recognizing that each data loss factor has unique characteristics, this method and apparatus can solve the majority of cases using a general technique, bringing simplicity to storage environments, while increasing data availability and reliability. More importantly, physical and logical disruptions are treated equally as part of a complete data protection plan.

This technique offers a high degree of confidence in the ability to restore the data. It results in very appropriate strategies for physical and logical failures, and a very cost-effective use of storage. In addition, this approach supports much more flexibility in evaluating the scope of storage replication technologies that are available and appropriate for the specific application server.

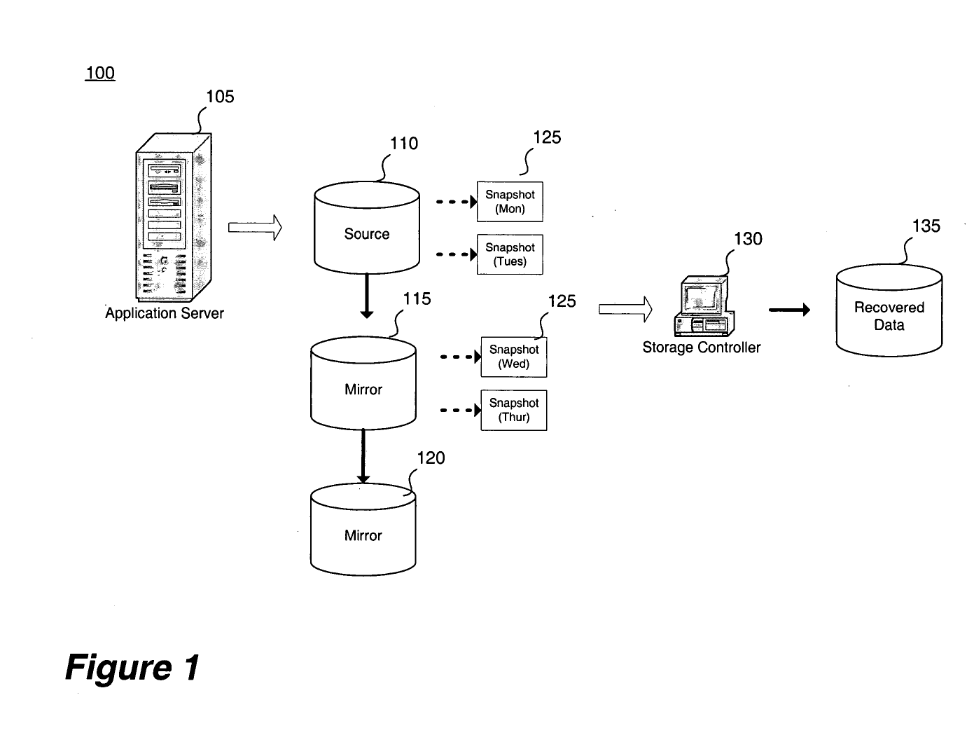

FIG. 1 illustrates a diagram of one possible embodiment of the data protection system 100. An application server 105 stores a set of source data 110. The server 105 also creates a set of mirror data 115 that matches the set of source data 110. Mirroring is the process of copying data continuously in real time to create a physical copy of the volume. Mirroring often does not end unless specifically stopped. A second set of mirror data 120 is also created from the first set of mirror data 115. A snapshot 125 of the set of mirror data 115 and the source data 110 is taken to record the state of the data at various points in time. Snapshot technologies provide logical PIT copies of the volumes or files containing the set of source data 110. Snapshot-capable volume controllers or file systems configure a new volume but point to the same location as the original source data 110. A storage controller 130, running a recovery application, then recovers any missing data 135.

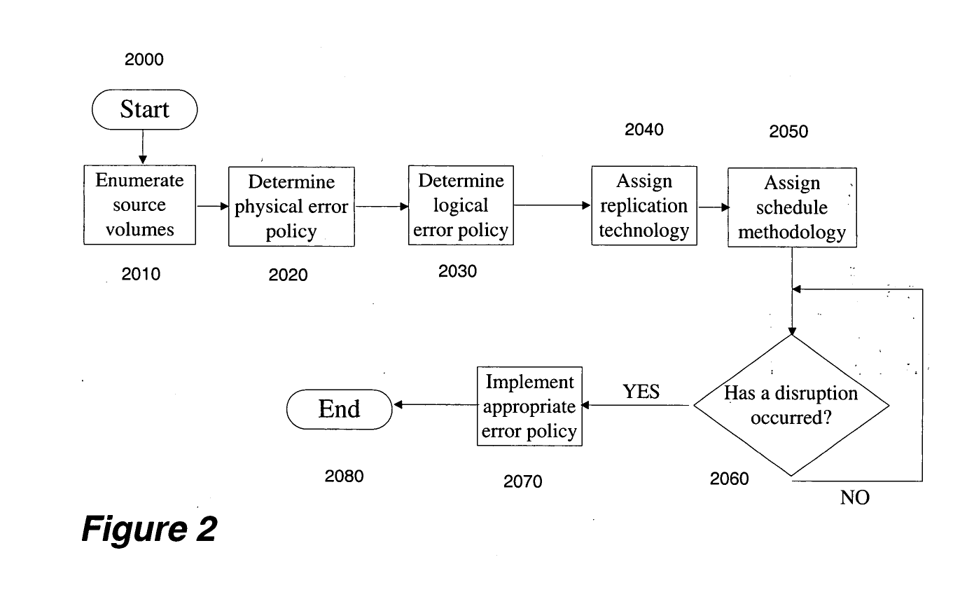

FIG. 2 illustrates in a flowchart one possible embodiment of a process for creating an integrated set of data protection and replication policies in order to facilitate data management and recovery. At step 2000, the process begins and at step 2010, the storage controller 125 enumerates a source volume 110 by storing a primary set of data in a data storage medium or memory. This memory may include a hard disk drive, a removable disk drive, a tape, an EEPROM, or other memory storage devices. In step 2020, the storage controller 125 determines a physical error policy, for example, one or more mirrors of source data stored locally to protect from any physical damage to the source data, as depicted in FIG. 1. In step 2030, the storage controller 125 determines a logical error policy, for example, any number of PIT replications of source data stored in a variety of memory storage mediums, each data replication spanning a particular time period. In step 2040, the storage controller 125 assigns a replication technology, by using default parameters or setting specific parameters, for example. In step 2050, the storage controller 125 leverages traditional scheduling methodology to specify scheduling parameters such as frequency, execution range, and specific time. In step 2060, the storage controller 125 monitors and recovers data by executing the replication policy and monitoring the condition of the mirror 115 to determine whether a disruption has occurred. A disruption may be a physical or logical error, for example. If a disruption has not occurred, storage controller 125 again performs step 2060. If a disruption has occurred, control passes to step 2070. In step 2070, a storage controller 125 implements the appropriate error policy to correct the disruption. In step 2080, the process ends.

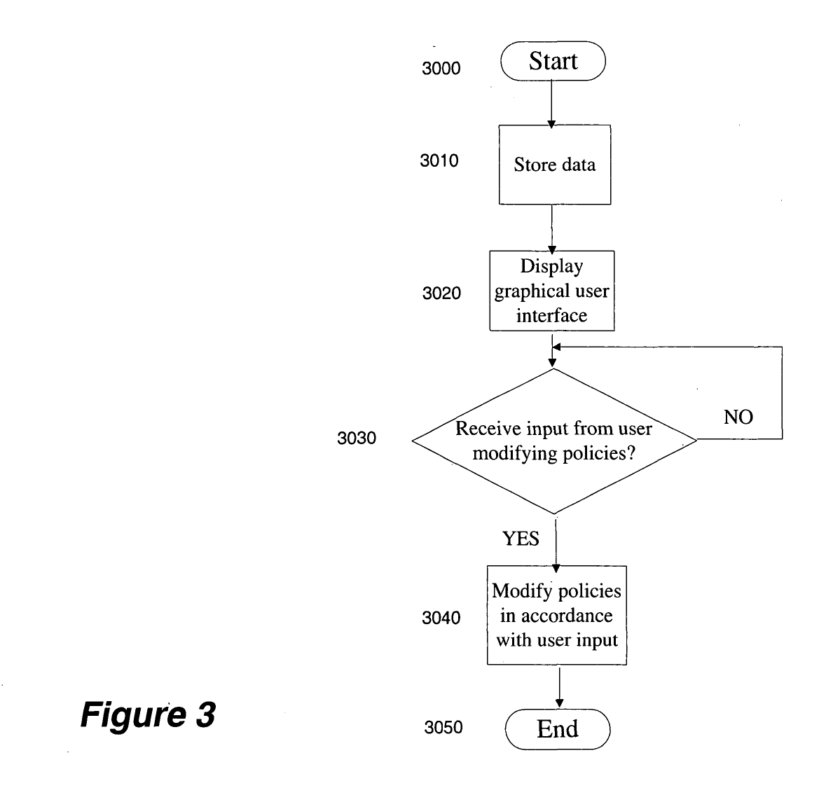

FIG. 3 illustrates in a flowchart one possible embodiment of a process for modifying an integrated set of data protection and replication policies in accordance with user input in order to facilitate data management and recovery. At step 3000, the process begins and at step 3010, a storage controller 125 enumerates a source volume 110 by storing a primary set of data in a data storage medium or memory. As discussed above, this memory may include a hard disk drive, a removable disk drive, a tape, an EEPROM, or other memory storage devices. In step 3020, the storage controller 125 displays a graphical user interface. In step 3030, the storage controller 125 determines whether any input has been received from the user modifying a policy. The policies to be modified may include a physical error policy, a logical error policy, a scheduling policy, or any other type of data protection or data replication policy. The user may modify a policy by means of an input device such as a mouse, keyboard, pointing device, touch screen, stylus, joystick, game pad, track ball, light pen, microphone, or speech recognition device. If the user does not provide such input, the storage controller 125 repeats the determination at step 3030. If the user does provide input to modify a policy, the storage controller 125 proceeds to step 3040, wherein the storage controller 125 modifies the policy in accordance with user input. In step 3050, the process ends.

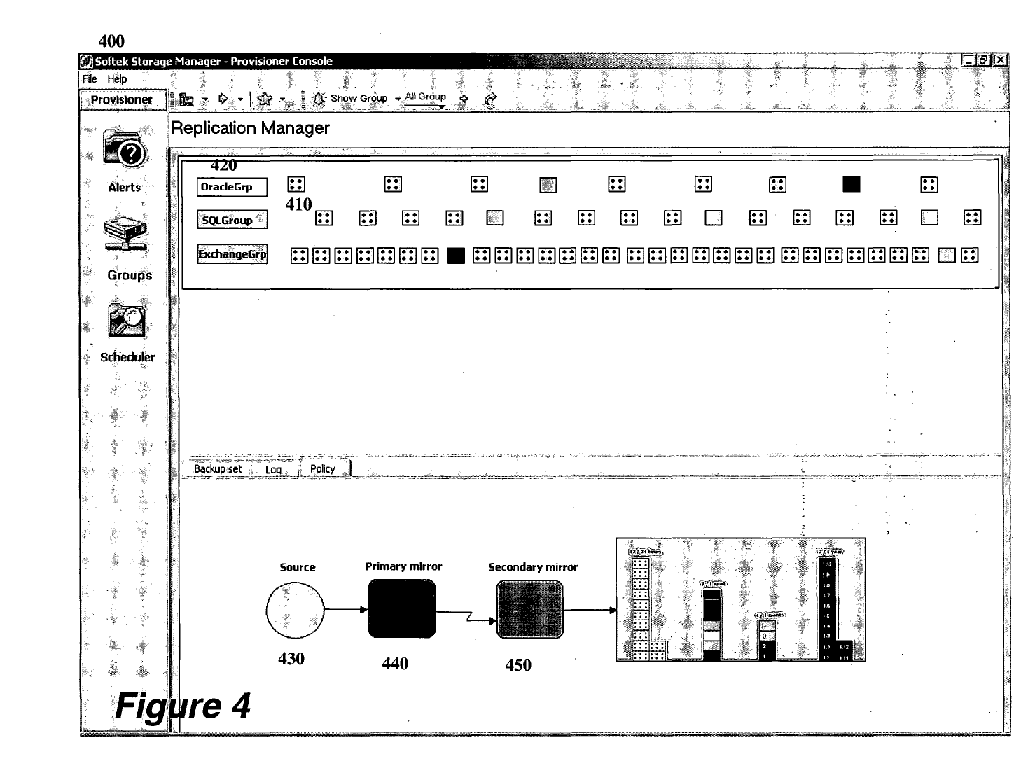

FIG. 4 illustrates one embodiment of a GUI 400 capable of time instantiating data protection and replication policies to facilitate data management and recovery. In this GUI, a block represents each replication of the primary set of data. Block 410 represents a partial or complete replication of the primary set of data with respect to a particular data set 420. The number of blocks for a particular data set may be changed, causing more or less replications to occur over a given time period. The type of blocks may also be changed to indicate the type of replication to be performed, be it a full copy or only a partial set of the data. Source 430 is protected from disruption by primary mirror 440 and secondary mirror 450. Drop-down menus, cursor activated fields, lookup boxes, and other interfaces known in the art may be added to allow the user to control performance of the protection process. Other constraints may be placed on the complete data protection scheme as required by the user.

As shown in FIG. 1, the method of this invention may be implemented using a programmed processor. However, the method can also be implemented on a general-purpose or a special purpose computer, a programmed microprocessor or microcontroller, peripheral integrated circuit elements, an application-specific integrated circuit (ASIC) or other integrated circuits, hardware/electronic logic circuits, such as a discrete element circuit, a programmable logic device, such as a PLD, PLA, FPGA, or PAL, or the like.

While the invention has been described with reference to the above embodiments, it is to be understood that these embodiments are purely exemplary in nature. Thus, the invention is not restricted to the particular forms shown in the foregoing embodiments. Various modifications and alterations can be made thereto without departing from the spirit and scope of the invention.

1. A method comprising:
storing a set of data on a data storage medium;
displaying a graphical user interface to a user, wherein the graphical user interface is a graphical representation of a data protection policy and a replication policy; and
providing the user with an ability to modify the data protection policy and the replication policy through the graphical user interface.

2. The method of claim 1, further comprising modifying the data protection policy based on input received from the user through the graphical user interface.

3. The method of claim 1, further comprising modifying the replication policy based on input received from the user through the graphical user interface.

4. The method of claim 1, wherein the graphical user interface displays a logical source volume.

5. The method of claim 1, wherein the data protection policy is a physical failure policy.

6. The method of claim 1, wherein the data protection policy is a logical failure policy.

7. The method of claim 1, wherein the replication policy is a scheduling policy.

8. A set of instructions residing in a storage medium, the set of instructions capable of being executed by a controller to implement a method for processing data, the method comprising:
storing a set of data on a data storage medium;
displaying a graphical user interface to a user, wherein the graphical user interface is a graphical representation of a data protection policy and a replication policy; and
providing the user with an ability to modify the data protection policy and the replication policy through the graphical user interface.

9. The set of instructions of claim 8, wherein the method further comprises modifying the data protection policy based on input received from the user through the graphical user interface.

10. The set of instructions of claim 8, wherein the method further comprises modifying the replication policy based on input received from the user through the graphical user interface.

11. The set of instructions of claim 8, wherein the graphical user interface displays a logical source volume.

12. The set of instructions of claim 8, wherein the data protection policy is a physical failure policy.

13. The set of instructions of claim 8, wherein the data protection policy is a logical failure policy.

14. The set of instructions of claim 8, wherein the replication policy is a scheduling policy.

15. A processing system comprising:
a memory that stores a set of data;
a controller that enacts a data protection policy and a replication policy to protect the set of data against disruptions;
a display that shows to a user a graphical user interface providing a graphical representation of the data protection policy and the replication policy; and
an input device that provides the user with the ability to modify the data protection policy and the replication policy through the graphical user interface.

16. The processing system of claim 15, wherein the graphical user interface displays a logical source volume.

17. The processing system of claim 15, wherein the data protection policy is a physical failure policy.

18. The processing system of claim 15, wherein the data protection policy is a logical failure policy.

19. The processing system of claim 15, wherein the replication policy is a scheduling policy.

20. The processing system of claim 15, wherein the input device includes at least one of a mouse, keyboard, pointing device, touch screen, stylus, joystick, game pad, track ball, light pen, microphone, and speech recognition device.
